(19) United States
(12) Patent Application Publication
(10) Pub. No.: US 2019/0244182 A1
(43) Pub. Date: Aug. 8, 2019

(54) METHOD AND SYSTEM FOR FACILITATING ONLINE PURCHASES

(71) Applicant: Mastercard International Incorporated, Purchase, NY (US)

(72) Inventors: Ajay SINHA, Maharashtra (IN); Dhaval PATIL, Maharashtra (IN)

(21) Appl. No.: 16/268,711

(22) Filed: Feb. 6, 2019

(30) Foreign Application Priority Data
Feb. 6, 2018 (SG) 10201801012Y

(51) Int. Cl. G06Q 20/08; G06Q 10/08

(52) U.S. Cl. CPC G06Q 20/085; G06Q 10/0835

(57) ABSTRACT

A method for facilitating online purchases includes a first request that is received by a first server for initiating a transaction for a product purchased by a customer. The first request includes at least one of a purchase amount of the product and a set of parameters such as a shipping time of the product. A hold duration is determined to reserve the purchase amount from an account of the customer, based on the first request. The transaction is processed for performing one of a release and a capture of the purchase amount from the account. The purchase amount is released, when the customer initiates a return of the product within the hold duration. The purchase amount is captured, when either the customer accepts the product within the hold duration or the hold duration elapses.

### CROSS-REFERENCE TO RELATED APPLICATIONS

This application claims priority to Singapore Patent Application No. 10201801012Y filed on Feb. 6, 2018, which is hereby incorporated by reference in its entirety.

### FIELD OF THE INVENTION

The present invention relates to a method and system for electronic commerce (e-commerce) transactions, and more particularly to a method and system for facilitating online purchases.

### BACKGROUND

Proliferation of the internet has led to an emergence of e-commerce as a one-stop solution for shopping. After the introduction of smartphones and advent of continuous internet connectivity, e-commerce has become even more popular. E-commerce websites offer a wide catalog of products at the best available price to customers. These days customers prefer such e-commerce websites over brick and mortar stores for purchasing products of their choice. In addition to reducing physical efforts, the e-commerce websites also minimize time that the customers have to spend on shopping. The e-commerce websites offer a wide array of payment options, such as net-banking, credit and debit cards, cash-on-delivery, or the like, for purchasing the products.

Every e-commerce website has its own return policy that enables the customers to return the purchased products. A customer may opt to return a purchased product due to various factors, such as expectation mismatch, finding a better deal on another e-commerce website, or the like. The customer initiates a return process with the e-commerce website and a purchase amount that the customer had paid previously for purchasing the product is refunded after the completion of the return process.

Typically, it takes 5-7 business days for the refund to reflect in an account of the customer, which causes inconvenience to the customer. In addition, the customer has to constantly follow-up with the e-commerce website and corresponding issuer bank to get an update on the status of the refund. This constant follow-up further adds to the inconvenience caused to the customer. Tracking of refund is not only inconvenient for the customers, but also for merchants of the e-commerce websites, as a single merchant has to track the refund of multiple customers simultaneously. Keeping a track of all the refunds initiated by the customers increases processing overhead for merchant systems, which may result in delayed refunds.

In light of the foregoing, there exists a need for a solution that facilitates timely refund of purchase amounts of the returned products without causing inconvenience to merchants and customers.

### SUMMARY

In an embodiment of the present invention, a method for facilitating online purchases is provided. A first request is received by a first server, such as a merchant server, a payment network server, or an issuer server, to initiate a transaction for a product purchased by a customer. The first request includes at least one of a purchase amount of the product and a set of parameters. A hold duration is determined by the first server to reserve the purchase amount from an account of the customer, based on the first request. The transaction is processed by the first server for performing one of a release and a capture of the purchase amount from the account. The purchase amount is released, when the customer initiates a return of the product within the hold duration.

In another embodiment of the present invention, a system for facilitating online purchases is provided. The system includes an issuer server that includes a processor. The processor receives a first request from a merchant server to initiate a transaction for a product purchased by a customer. The first request includes at least a purchase amount of the product and a set of parameters. The processor determines a hold duration to reserve the purchase amount from an account of the customer, based on the first request. The processor processes the transaction for performing one of a release and a capture of the purchase amount from the account. The purchase amount is released, when the customer initiates a return of the product within the hold duration.

In yet another embodiment of the present invention, a method for facilitating online purchases is provided. A first authorization option is presented on a computing device of a customer by way of a merchant website, when the customer selects a first product, listed for sale on the merchant website, for purchasing. A set of parameters is determined by the merchant server, when the customer selects the first authorization option. A first request is transmitted by the merchant server to a first server (such as a payment network server or an issuer server) to initiate a transaction for the purchase of the first product. The first request includes the set of parameters and a purchase amount of the first product. Information of a hold duration is received by the merchant server from the first server based on the first request. The purchase amount is reserved from an account of the customer for the hold duration. A second request is communicated by the merchant server to the first server for processing the transaction. The first server processes the transaction for performing one of a release and a capture of the purchase amount from the account. The purchase amount is released, when the customer initiates a return of the product within the hold duration.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates a communication environment for facilitating online purchases, in accordance with an embodiment of the present invention;

FIG. 2 is a block diagram that illustrates a payment network server of the communication environment of FIG. 1, in accordance with an embodiment of the present invention;

FIG. 3 is a block diagram that illustrates an issuer server of the communication environment of FIG. 1, in accordance with an embodiment of the present invention;

FIGS. 4A-4C are process flow diagrams that illustrate exemplary scenarios for facilitating online purchases using the communication environment of FIG. 1, in accordance with an embodiment of the present invention;

FIGS. 5A-5C are process flow diagrams that illustrate exemplary scenarios for facilitating online purchases using the communication environment of FIG. 1, in accordance with various embodiments of the present invention;

FIGS. 6A and 6B collectively represent a flow chart that illustrates a method for facilitating online purchases implemented using the communication environment of FIG. 1, in accordance with an embodiment of the present invention;

FIGS. 7A-7C collectively represent a flow chart that illustrates a method for facilitating online purchases implemented using the communication environment of FIG. 1, in accordance with another embodiment of the present invention;

FIGS. 8A-8C collectively represent a flow chart that illustrates a method for facilitating online purchases implemented using the communication environment of FIG. 1, in accordance with yet another embodiment of the present invention;

FIGS. 9A-9C collectively represent a flow chart that illustrates a method for facilitating online purchases implemented using the communication environment of FIG. 1, in accordance with yet another embodiment of the present invention;

FIG. 10 represents a high-level flow chart that illustrates a method for facilitating online purchases implemented using the communication environment of FIG. 1, in accordance with an embodiment of the present invention; and

FIG. 11 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Various embodiments of the present invention provide a method and system for facilitating online purchases. A customer is presented with a first authorization option, when the customer purchases a product through an e-commerce website or a mobile application of the e-commerce website. The customer selects the first authorization option and performs a transaction for purchasing the product. Based on the selection of the first authorization option, a merchant server determines a set of parameters such as a category of the product, a shipping time associated with a delivery of the product to the customer, a hold duration recommendation, or a rating of the customer. The merchant server then transmits a first request to a first server (i.e., a payment network server or an issuer server). The first request includes the set of parameters and a purchase amount of the product. The first server determines a hold duration for reserving the purchase amount from an account of the customer, based on the first request. The first server processes the transaction for performing one of a release or capture of the purchase amount from the account based on the hold duration and one or more actions performed by the customer. When the customer initiates the return of the product within the hold duration, the purchase amount is released from the account and is made available for use to the customer. When the customer accepts the product within the hold duration, the purchase amount is captured from the account and is credited to an account of a merchant. When the customer neither accepts nor initiates the return of the first product within the hold duration and the hold duration elapses, the purchase amount is captured from the account and is credited to the account of the merchant.

Thus, the method and system of the present invention enable a timely refund of the purchase amount to the customer without causing any inconvenience to the merchant and the customer. As the purchase amount is immediately reflected in the account of the customer in an event that the customer initiates the return of the product, the need for the customer to follow-up with the merchant and the issuer bank for the refund is eliminated. When the customer purchases the product, the first server only reserves the purchase amount from the account of the customer. The actual deduction of the purchase amount happens only when the customer accepts the product or when the hold duration elapses. Thus, the merchant server does not require to track the status of refunds of multiple customers, thereby reducing the processing overhead of merchant systems.

### Terms Description (in Addition to Plain and Dictionary Meaning)

Online purchase is a category of e-commerce that allows customers to purchase various products from a merchant over the internet using an e-commerce website or a mobile application of the e-commerce website.

Pre-authorization, preauth, or authorization hold is a two-step transaction. At the first step, a purchase amount of a product purchased by a user is held unavailable for use from an account of the user for a hold duration. At the second step, the purchase amount is either captured or released from the account or credit line balance associated with the account. The purchase amount is captured, when the user accepts the product on delivery or when the hold duration elapses. The purchase amount is released in an event that the user initiates a return of the product. In such a case, the purchase amount is rendered available for use again to the user.

Hold duration is a time period for which a purchase amount associated with a transaction is held unavailable for use. Determination of the hold duration is based on a set of parameters associated with a product purchased by performing the transaction. The set of parameters includes a category of the product, a shipping time associated with a delivery of the product, a hold duration recommendation, or a rating of a user who has purchased the product. In one embodiment, the hold duration is longer than the shipping time.

Transaction cards are suitable payment devices, such as debit cards, credit cards, prepaid cards, gift cards, promotional cards, contactless cards, and/or other devices that may hold identification information of an account. The transaction cards can be used to perform transactions, such as deposits and withdrawals, credit transfers, purchase payments, and the like. In an embodiment, the transaction cards may be radio frequency identification (RFID) or near field communication (NFC) enabled for performing contactless payments.

Merchant is an entity that offers various products and/or services in exchange of payments. The merchant may establish a merchant account with a financial institution, such as a bank (hereinafter “acquirer bank”) to accept the payments from several users by use of one or more payment methods.

Merchant website is an e-commerce website that offers a user a catalog of products and/or services to be purchased and/or availed. The merchant website is hosted on a merchant server, and may be accessed by a user from a mobile application or by way of an internet browser. The merchant website may be built using programming languages such as Hypertext Markup Language® (HTML), Cascading Style Sheets® (CSS), Javascript® (JS), and the like. The merchant website may be an e-commerce website such as Amazon®, Costco®, Zappos®, eBay®, and the like.

Issuer or issuer bank is a financial institution, such as a bank, where accounts of several users are established and maintained. The issuer bank ensures payment for authorized transactions in accordance with various payment network regulations and local legislation.

Payment network is a transaction card association that acts as an intermediate entity between acquirer banks and issuer banks to authorize and fund transactions. Examples of payment networks include MasterCard®, American Express®, VISA®, Discover®, Diners Club®, and the like. The payment network settles the transactions between various acquirer banks and issuer banks, when transaction cards are used for initiating transactions. The payment network authorizes a transaction card used by a user for performing a transaction. For example, if a user uses a stolen debit card for performing a transaction, the payment network may not authorize the transaction card and thus may not authorize the transaction.

A server is a physical or cloud data processing system on which a server program runs. The first server may be implemented in hardware or software, or a combination thereof. In one embodiment, the first server may be implemented in computer programs executing on programmable computers, such as personal computers, laptops, or a network of computer systems. The first server may correspond to one of a payment network server, an issuer server, a digital wallet server, an acquirer server, or a merchant server.

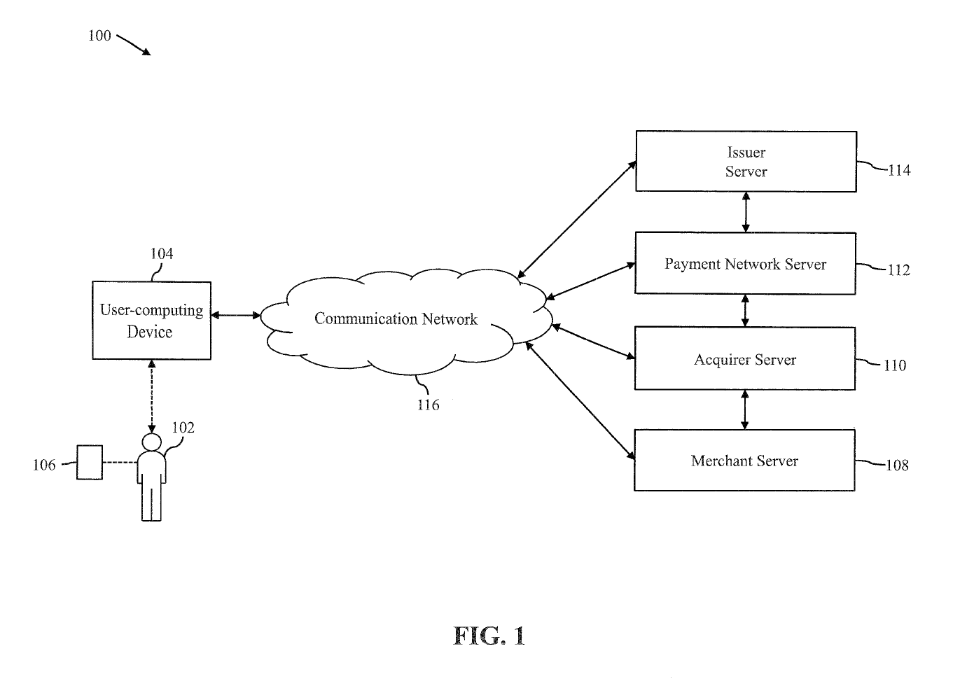

Referring now to FIG. 1, a block diagram that illustrates a communication environment 100 for facilitating online purchases, in accordance with an embodiment of the present invention, is shown. The communication environment 100 includes a user 102 in possession of a user-computing device 104 and a transaction card 106. The communication environment 100 further includes a merchant server 108, an acquirer server 110, a payment network server 112, and an issuer server 114. The user-computing device 104 communicates with the merchant server 108, the acquirer server 110, the payment network server 112, and the issuer server 114 by way of a communication network 116.

The user 102 is an individual, who purchases a first product that is listed for sale on an e-commerce website of a merchant or a mobile application of the e-commerce website. The user 102 may perform a transaction from her account to purchase the first product. In one example, the account of the user 102 is maintained by a financial institution, such as an issuer bank. In another example, the account of the user 102 is an e-wallet maintained by a third-party service provider or the merchant. The user 102 may use various payment modes, such as net-banking, e-wallets, the transaction card 106, or the like, for performing the transaction. The transaction card 106 may have been issued to the user 102 by the issuer bank where the account of the user 102 is maintained. The transaction card 106 is linked to the account of the user 102. Examples of the transaction card 106 include a credit card, a debit card, a membership card, a promotional card, a charge card, a prepaid card, a gift card, or the like. In one embodiment, the transaction card 106 may be a physical card. In another embodiment, the transaction card 106 may be a virtual card or a payment token that is stored electronically in memory (not shown) of the user-computing device 104. The transaction card 106 stores identification information of the account to which it is linked, in form of an electronic chip or a machine readable magnetic strip. The identification information may include an account number, a name of an account holder (i.e., the user 102), or the like. The transaction card 106 further has a unique card number, an expiry date, a card security code, and a card type associated to it. When the first product is delivered to the user 102, the user 102 may either initiate a return of the first product or accept the first product. The user 102 initiates the return of the first product by sending a message from the user-computing device 104.

The user-computing device 104 is a communication device of the user 102. Registered contact information of the user 102, such as a registered contact number or a registered e-mail ID, may be associated with the user-computing device 104. The user 102 registers the contact number and the e-mail ID with the issuer bank, at the time she sets up the account with the issuer bank. Thus, the user 102 accesses all calls/messages/e-mails that are made or sent to the registered contact information by using the user-computing device 104. In one embodiment, the user 102 accesses the e-commerce website through the user-computing device 104 for purchasing the first product. In another embodiment, the user-computing device 104 is installed with the mobile application of the e-commerce website using which the user 102 purchases the first product. Examples of the user-computing device 104 include, but are not limited to, a mobile phone, a smartphone, a laptop, a tablet, a phablet, or any other communication device.

The merchant server 108 is a computing server or a payment gateway server that is associated with a merchant (not shown). In one embodiment, the merchant server 108 hosts the e-commerce website that provides a catalog of products that are listed for sale to the user 102. In another embodiment, the merchant server 108 hosts the mobile application of the e-commerce website for providing the catalog of products to the user 102. Examples of the e-commerce website include Amazon, Costco, Zappos, eBay, or the like. The merchant may establish a merchant account with an acquirer bank to accept payments for the product and/or service purchases. For example, the merchant may accept the payment for the first product purchased by the user 102. In one embodiment, the merchant is registered with at least one of the payment network server 112 or the issuer server 114 for getting a permission to offer a pre-authorization option (i.e., a first authorization option) to the user 102, when the user 102 selects the first product for purchasing. The pre-authorization option is a two-step transaction, which includes reserving a purchase amount of the first product for a hold duration, and capturing or releasing the purchase amount at the end of the hold duration based on one or more actions performed by the user 102. When the user 102 performs a transaction to purchase the first product by using the pre-authorization option, the merchant server 108 identifies a set of parameters associated with the first product and transmits a transaction request (i.e., a first request) to one of the acquirer server 110, the payment network server 112, or the issuer server 114 for initiating the transaction. The transaction request includes the set of parameters, the purchase amount of the first product, transaction details, and/or data fields that are pursuant to one or more standards for the interchange of transaction messages, such as the ISO8583 standard. The set of parameters includes a category of the first product, a shipping time associated with a delivery of the first product to the user 102, a hold duration recommendation, or a rating of the user 102. The transaction details include identification information of the account, a time and a date of the transaction, a unique card number, a card type, or the like. In one embodiment, the merchant server 108 may maintain the e-wallet of the user 102.

The acquirer server 110 is a computing server that is associated with the acquirer bank. The acquirer bank processes the transaction request received from the merchant server 108 by using the acquirer server 110. The acquirer server 110 transmits the transaction request to the payment network server 112 via the communication network 116. In one embodiment, the acquirer server 110 credits or debits the merchant account in the acquirer bank with the purchase amount, when the transaction is captured at the issuer server 114.

The payment network server 112 is a computing server that is associated with a payment network of transaction cards, i.e., the transaction card 106. The payment network server 112 represents an intermediate entity between the acquirer server 110 and the issuer server 114 for authorizing and funding the transactions performed by using the transaction cards, such as the transaction card 106. The payment network server 112 receives the transaction request from one of the merchant server 108 or the acquirer server 110. In one embodiment, when the user 102 selects the pre-authorization option for performing the transaction, the payment network server 112 determines the hold duration, based on the set of parameters included in the transaction request. The payment network server 112 then instructs the issuer server 114 to reserve the purchase amount from the account of the user 102 for the hold duration. In an alternate embodiment, the payment network server 112 transmits the transaction request to the issuer server 114 for determining the hold duration.

The issuer server 114 is a computing server that is associated with the issuer bank. The issuer bank is a financial institute that manages accounts of multiple users. Account details of the accounts established with the issuer bank are stored as account profiles in a memory of the issuer server 114 or on a cloud server associated with the issuer server 114. The account details may include an account balance, a credit line, details of an account holder, transaction history of the account holder, account identification information, or the like. The details of the account holder may include name, age, gender, physical attributes, registered contact number, alternate contact number, registered e-mail ID, or the like of the account holder. In one embodiment, the issuer server 114 receives the transaction request from one of the merchant server 108, the acquirer server 110, or the payment network server 112 for initiating the transaction. In one embodiment, based on the hold duration determined by the payment network server 112, the issuer server 114 reserves the purchase amount from the account of the user 102 for the hold duration. In an alternate embodiment, the issuer server 114 processes the transaction request received from the payment network server 112 and determines the hold duration. The issuer server 114 then reserves the purchase amount for the hold duration. The issuer server 114 further processes the transaction to release or capture the purchase amount from the account of the user 102 based on the actions performed by the user 102.

Methods for processing transactions via the issuer server 114 will be apparent to persons having skill in the art and may include processing a transaction via the traditional four-party system or the traditional three-party system.

Examples of the merchant server 108, the acquirer server 110, the payment network server 112, and the issuer server 114 include, but are not limited to, computers, laptops, mini-computers, mainframe computers, any non-transient and tangible machines that can execute a machine-readable code, a cloud-based server, or a network of computer systems.

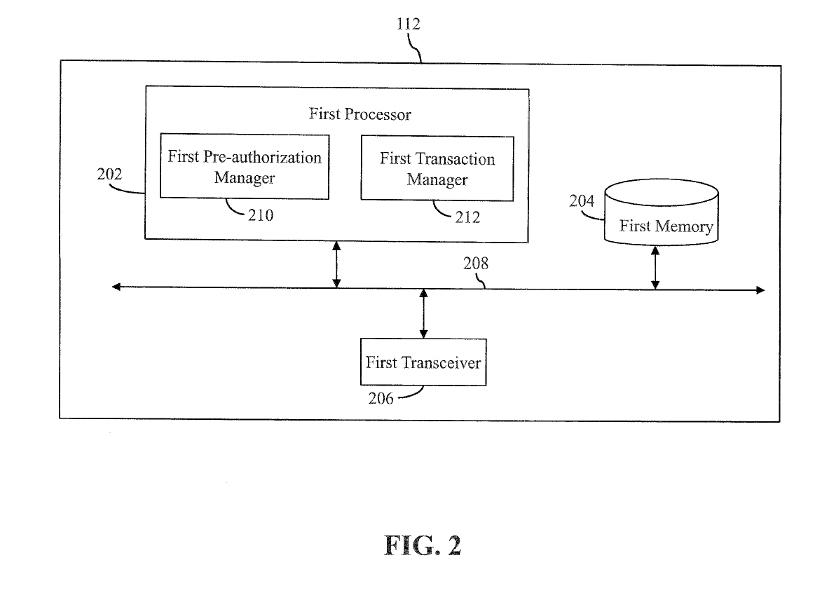

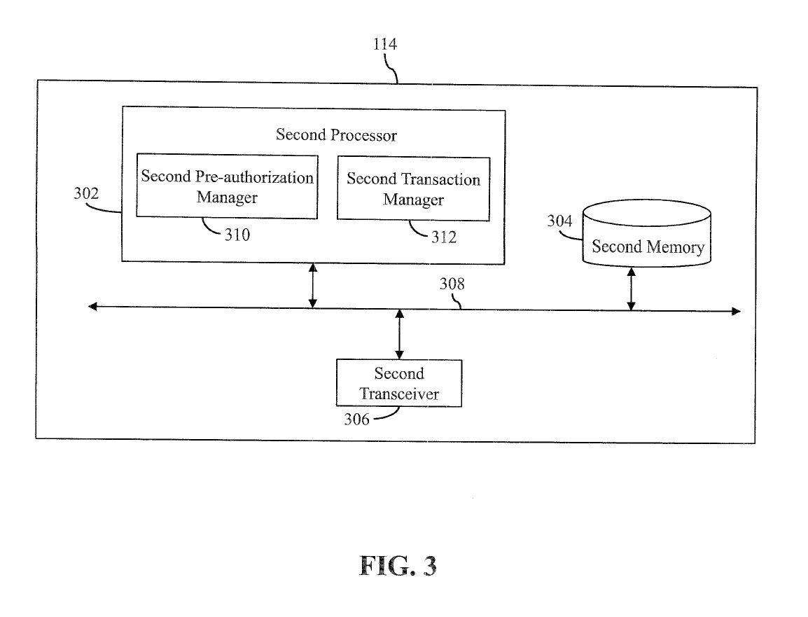

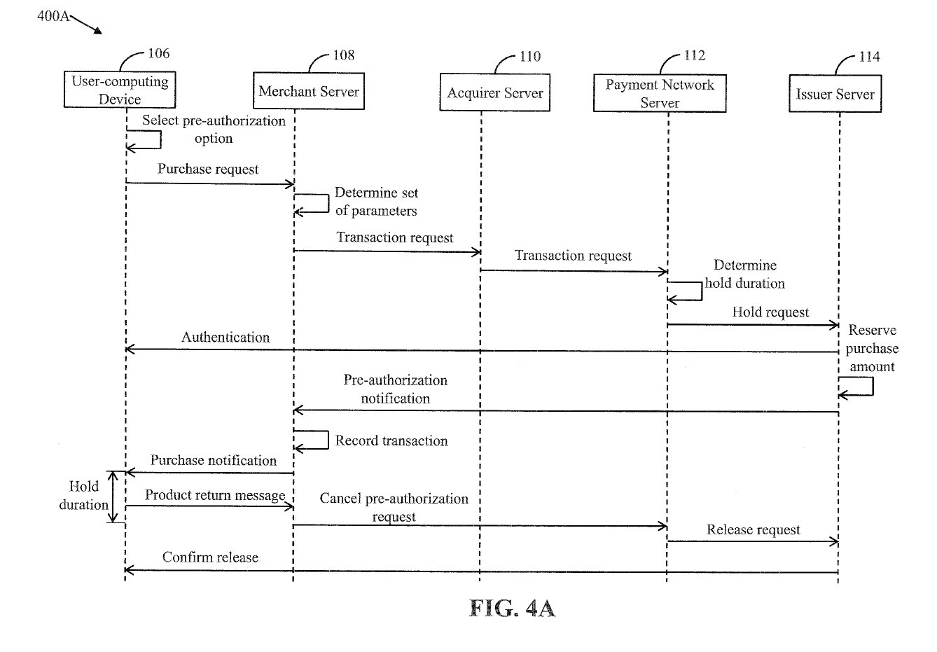

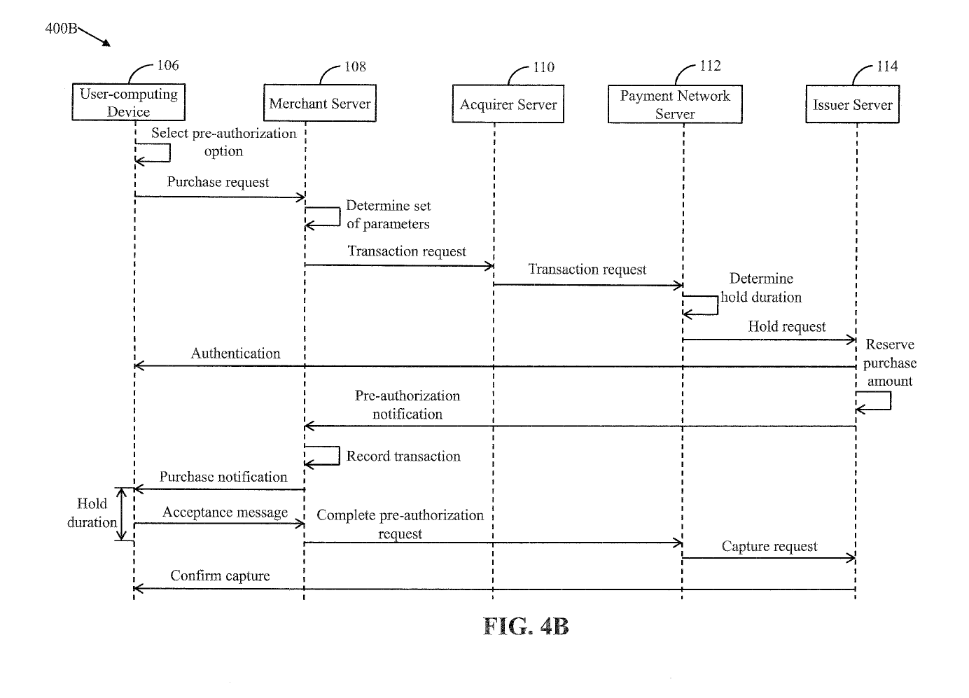

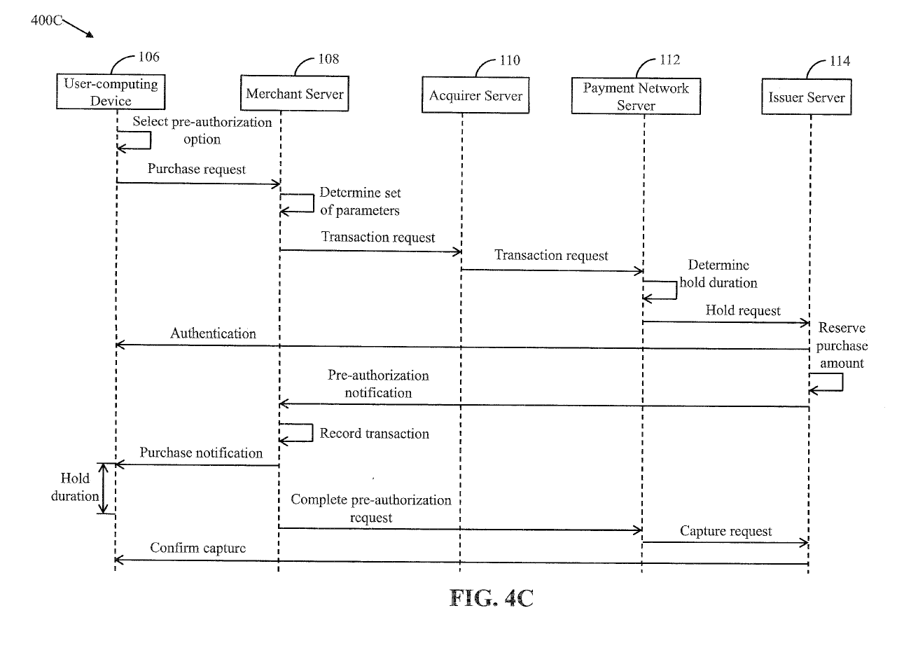

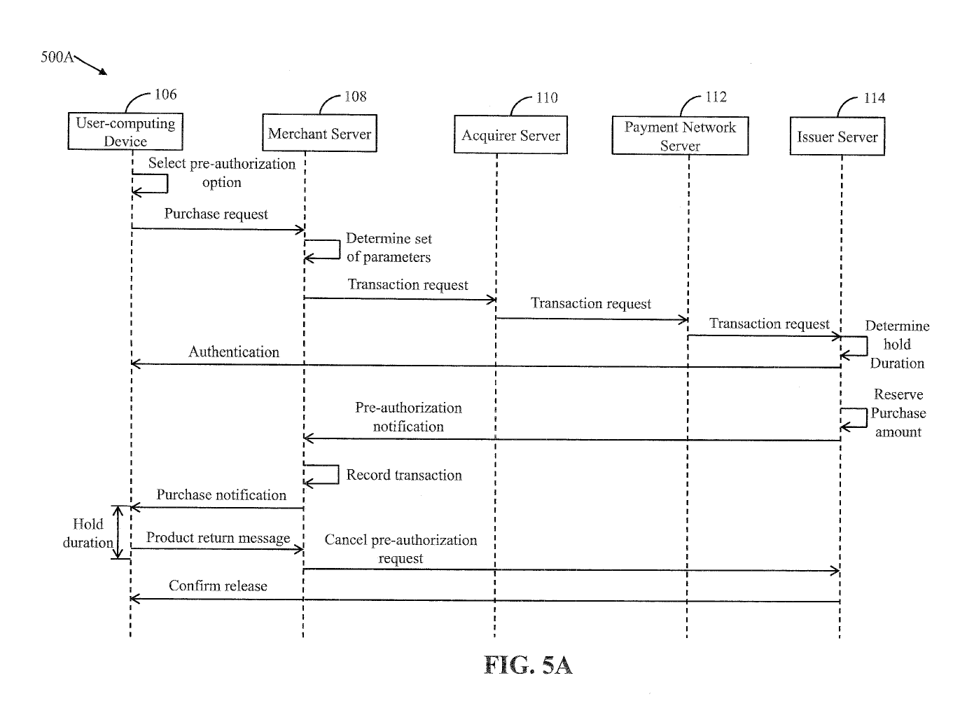

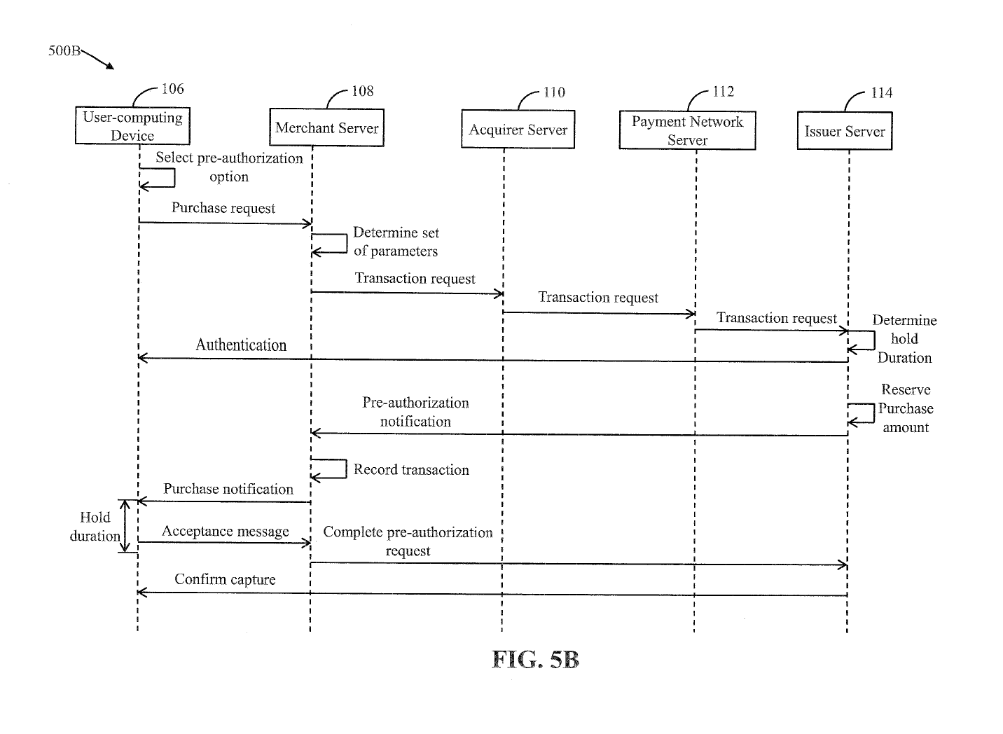

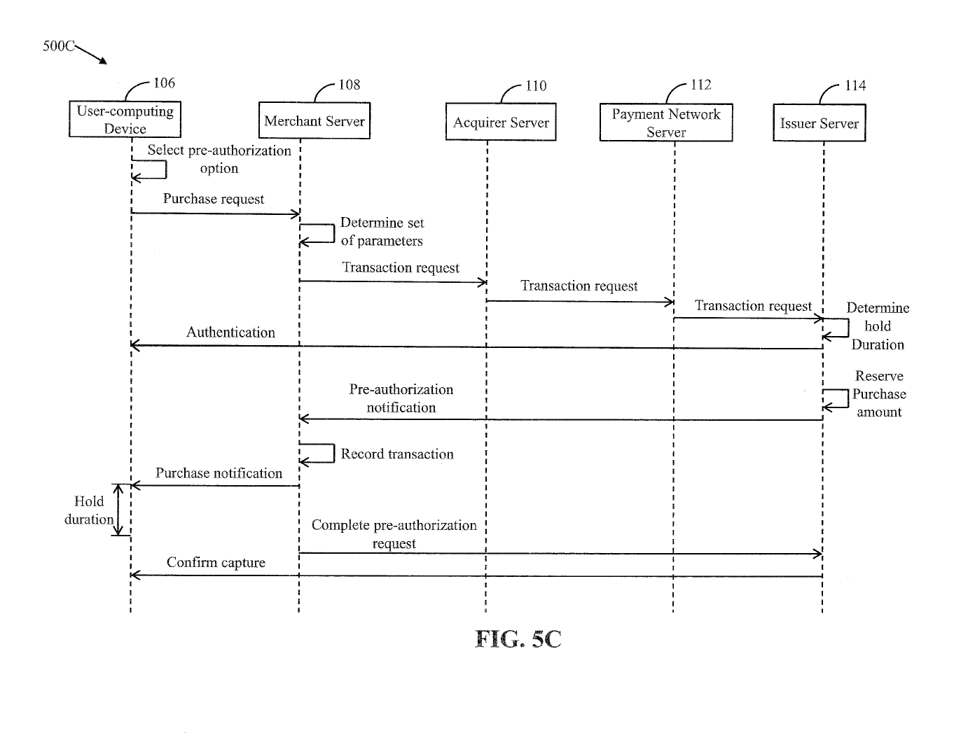

The communication network 116 is a medium through which content and messages are transmitted between various entities, such as the user-computing device 104, the merchant server 108, the acquirer server 110, the payment network server 112, and the issuer server 114. Examples of the communication network 116 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the communication environment 100 may connect to the communication network 116 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G) communication protocols, Long Term Evolution (LTE) communication protocols, or any combination thereof. Management of online purchases by using the communication environment 100 is explained in detail in conjunction with FIG. 2, FIG. 3, FIGS. 4A-4C, and FIGS. 5A-5C.

Referring now to FIG. 2, a block diagram that illustrates the payment network server 112 of the communication environment 100 of FIG. 1, in accordance with an embodiment of the present invention, is shown. The payment network server 112 includes a first processor 202, a first memory 204, and a first transceiver 206 that communicate with each other via a first bus 208. The first processor 202 includes a first pre-authorization manager 210 and a first transaction manager 212. It will be apparent to a person skilled in the art that the merchant server 108 may also be implemented by the block diagram of FIG. 2, without deviating from the spirit of the invention.

The first processor 202 includes suitable logic, circuitry, and/or interfaces to execute operations for managing online purchases and handling various transaction requests that are received from one or more entities, such as the user-computing device 104, the merchant server 108, the acquirer server 110, or the issuer server 114. The first processor 202 determines the hold duration for a purchase amount, when the user 102 performs a transaction by selecting the pre-authorization option. Examples of the first processor 202 include, but are not limited to, an application-specific integrated circuit (ASIC) processor, a reduced instruction set computing (RISC) processor, a complex instruction set computing (CISC) processor, a field-programmable gate array (FPGA), and the like. The first processor 202 executes the operations for managing online purchases by way of the first pre-authorization manager 210 and the first transaction manager 212.

The first memory 204 includes suitable logic, circuitry, and/or interfaces to store details of various merchants registered with the payment network server 112 for getting the permission to offer the pre-authorization option to users. The first memory 204 stores various transaction requests of various transactions performed by the users, such as the user 102. The first memory 204 further stores details of various issuer banks and various acquirer banks, which are participating members of the payment network. In one embodiment, the first memory 204 stores pre-authorization rules provided by each of the issuer banks and the acquirer banks, which are the participating members of the payment network. The pre-authorization rules are guidelines based on which the first processor 202 determines the hold duration, when a transaction request corresponding to an account maintained by the corresponding issuer bank is received. Examples of the first memory 204 include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the first memory 204 in the payment network server 112, as described herein. In another embodiment, the first memory 204 may be realized in form of a database server or a cloud storage working in conjunction with the payment network server 112, without departing from the scope of the invention.

The first transceiver 206 transmits and receives data over the communication network 116 using one or more communication network protocols. The first transceiver 206 transmits/receives various requests and messages to/from at least one of the user-computing device 104, the merchant server 108, the acquirer server 110, the issuer server 114, or other entities that are pursuant to one or more standards for the interchange of transaction messages, such as the ISO8583 standard. Examples of the first transceiver 206 include, but are not limited to, an antenna, a radio frequency transceiver, a wireless transceiver, a Bluetooth transceiver, an ethernet port, a universal serial bus (USB) port, or any other device configured to transmit and receive data.

The first pre-authorization manager 210 includes suitable logic, circuitry, and/or interfaces for determining the hold duration, when a transaction request for which the user 102 had selected the pre-authorization option is received. The first pre-authorization manager 210 determines the hold duration based on the set of parameters included in the transaction request. The first pre-authorization manager 210 further utilizes the pre-authorization rules specified by the issuer bank, corresponding to the transaction request, for determining the hold duration. The first pre-authorization manager 210 generates and transmits a hold request to the issuer server 114 to reserve the purchase amount from the account of the user 102 for the hold duration. During the hold duration, the purchase amount is held unavailable for use by the user 102. In one embodiment, when the user 102 initiates the return of the first product within the hold duration, the first pre-authorization manager 210 generates and transmits a release request to the issuer server 114 to release the purchase amount from the account of the user 102. Based on the release request, the purchase amount is released from the account of the user 102 and is made available to the user 102 for use. In another embodiment, when the user 102 accepts the first product within the hold duration, the first pre-authorization manager 210 generates and transmits a capture request to the issuer server 114 to capture the purchase amount from the account of the user 102. In yet another embodiment, when the user 102 neither accepts the first product nor initiates the return of the first product within the hold duration, the first pre-authorization manager 210 generates and transmits the capture request to the issuer server 114 at the end of the hold duration. In other words, when the hold duration elapses and the user 102 has not yet accepted the first product or initiated the return of the first product, the first pre-authorization manager 210 transmits the capture request to the issuer server 114. Based on the capture request, the purchase amount is captured from the account of the user 102 and is credited to the merchant account maintained at the acquirer bank.

The first transaction manager 212 includes suitable logic, circuitry, and/or interfaces for authorizing transactions based on corresponding transaction requests. For example, based on the transaction request of the user 102, the first transaction manager 212 identifies the issuer bank where the account of the user 102 is maintained. The first transaction manager 212 then requests the issuer bank to further process the transaction. The functions performed by the payment network server 112 for facilitating the online purchases are explained later in conjunction with FIGS. 4A-4C.

Referring now to FIG. 3, a block diagram that illustrates the issuer server 114 of the communication environment 100 of FIG. 1, in accordance with an embodiment of the present invention, is shown. The issuer server 114 includes a second processor 302, a second memory 304, and a second transceiver 306 that communicate with each other via a second bus 308. The second processor 302 includes a second pre-authorization manager 310 and a second transaction manager 312. It will be apparent to a person skilled in the art that the merchant server 108 may also be implemented by the block diagram of FIG. 3, without deviating from the scope of the invention.

The second processor 302 includes suitable logic, circuitry, and/or interfaces to execute operations for managing online purchases and handling various transaction requests that are received from one or more entities, such as the user-computing device 104, the merchant server 108, the acquirer server 110, or the payment network server 112. The second processor 302 determines the hold duration for the purchase amount, when the user 102 selects the pre-authorization option for a transaction. Examples of the second processor 302 include, but are not limited to, an ASIC processor, a RISC processor, a CISC processor, an FPGA, and the like. The second processor 302 executes the operations for managing online purchases by way of the second pre-authorization manager 310 and the second transaction manager 312.

The second memory 304 includes suitable logic, circuitry, and/or interfaces to store details of various merchants who have registered with the issuer server 114 for getting the permission to offer the pre-authorization option to users. The second memory 304 stores various transaction requests associated with various transactions performed by the users, such as the user 102. In one embodiment, the second memory 304 stores the pre-authorization rules of the issuer bank. The pre-authorization rules are guidelines based on which the second processor 302 determines the hold duration. Examples of the second memory 304 include a RAM, a ROM, a removable storage drive, a HDD, a flash memory, a solid-state memory, and the like. It will be apparent to a person skilled in the art that the scope of the invention is not limited to realizing the second memory 304 in the issuer server 114, as described herein. In another embodiment, the second memory 304 may be realized in form of a database server or a cloud storage working in conjunction with the issuer server 114, without departing from the scope of the invention.

The second transceiver 306 transmits and receives data over the communication network 116 using one or more communication network protocols. The second transceiver 306 transmits/receives various requests and messages to/from at least one of the user-computing device 104, the merchant server 108, the acquirer server 110, the payment network server 112, or other entities that are pursuant to one or more standards for the interchange of transaction messages, such as the ISO8583 standard. Examples of the second transceiver 306 include, but are not limited to, an antenna, a radio frequency transceiver, a wireless transceiver, a Bluetooth transceiver, an ethernet port, a USB port, or any other device configured to transmit and receive data.

The second pre-authorization manager 310 includes suitable logic, circuitry, and/or interfaces for determining the hold duration, when the user 102 selects the pre-authorization option for a transaction. The second pre-authorization manager 310 determines the hold duration based on the set of parameters included in the transaction request and the pre-authorization rules specified by the issuer bank. The second pre-authorization manager 310 reserves the purchase amount from the account of the user 102 for the hold duration. In one embodiment, when the user 102 initiates the return of the first product within the hold duration, the second pre-authorization manager 310 releases the purchase amount from the account of the user 102. In another embodiment, when the user 102 accepts the first product within the hold duration, the second pre-authorization manager 310 captures the purchase amount from the account of the user 102. In yet another embodiment, when the user 102 neither accepts the first product nor initiates the return of the first product within the hold duration, the second pre-authorization manager 310 captures the purchase amount from the account of the user 102 at the end of hold duration and credits it to the merchant account maintained by the acquirer bank.

The second transaction manager 312 includes suitable logic, circuitry, and/or interfaces for authorizing transactions based on corresponding transaction requests. For example, based on the transaction request of the user 102, the second transaction manager 312 authenticates the user 102. The functions performed by the issuer server 114 for facilitating the online purchases are explained later in conjunction with FIGS. 5A-5C.

Referring now to FIGS. 4A-4C, process flow diagrams 400A-400C that illustrate exemplary scenarios for facilitating online purchases using the communication environment 100 of FIG. 1, in accordance with an embodiment of the present invention, are shown.

With reference to FIG. 4A, the process flow diagram 400A illustrates the user 102, who uses the user-computing device 104 to access an e-commerce website hosted by the merchant server 108. The e-commerce website presents to the user 102 a catalog of products that are listed for sale. In an alternate scenario, the user 102 may access the mobile application of the e-commerce website, installed on the user-computing device 104. The mobile application also presents the catalog of products.

The user 102 selects the first product from the catalog of products and proceeds to perform a transaction for purchasing the first product. The merchant server 108 offers various payment modes, such as net-banking, credit/debit card, e-wallet, or the like, to the user 102 for performing the transaction. The user 102 selects the credit/debit card payment mode for performing the transaction. Based on the selection of the credit/debit card payment mode, the merchant server 108 prompts the user 102 to provide details of her credit/debit card by way of a payment gateway (not shown) of the merchant server 108. The details of the transaction card 106 include the unique card number, the expiry date, the card security code, the card type, name of the user 102, or the like. In one scenario, the user 102 may manually enter the details of the transaction card 106 on the payment gateway. In another scenario, the user 102 may use the details of the transaction card 106 that are electronically stored in the memory of the user-computing device 104 for providing to the merchant server 108.

The merchant server 108 offers the pre-authorization option to the user 102 through one of the e-commerce website, the mobile application, or the payment gateway, when the user 102 provides the details of the transaction card 106. The user 102 selects the pre-authorization option for performing the transaction and a purchase request is transmitted from the user-computing device 104 to the merchant server 108. The purchase request indicates the selection of the pre-authorization option by the user 102. The merchant server 108 receives the purchase request associated with the first product and determines the set of parameters associated with the first product. The set of parameters includes a category of the first product, a shipping time associated with a delivery of the first product to the user 102, a hold duration recommendation, or a rating of the user 102.

The category of the first product indicates a type of the first product. Examples of various categories under which different products of the catalog may be listed include: apparels, electronics, appliances, home decor, home and kitchen, accessories, or the like. For example, when the category of the first product is ‘apparels’, it indicates that the first product is a clothing item.

The shipping time represents a time duration required for delivering the first product to the user 102, when the user 102 has purchased the first product. The shipping time is a function of distance between a dispatch address of the first product and a delivery address of the user 102. For example, the shipping time is more for a distance of 500 kilometers (km) as compared to a distance of 250 km.

The hold duration recommendation indicates a suggestion provided by the merchant server 108 to the payment network server 112 for the determination of the hold duration. The merchant server 108 provides the hold duration recommendation based on a purchase amount of the first product, a category of the first product, or a return policy associated with different categories of the products in the catalog. For example, a product with lower purchase amount may have a longer hold duration, a product in apparels category may have a longer hold duration as compared to a product in electronics category, as products in the apparels category may have a return policy of 30 days and products in the electronics category may have a return policy of 15 days, and so on.

The rating of the user 102 indicates a score assigned to the user 102 by the merchant server 108 based on a shopping history of the user 102. The shopping history of the user 102 represents previous shopping instances of the user 102 on the e-commerce website. For example, the user 102 may have shopped on the e-commerce website more frequently as compared to another user. In this scenario, the user 102 has a higher rating as compared to the other user. Hence, the merchant server 108 may recommend longer hold duration for the first product purchased by the user 102 than the second product purchased by the other user.

The merchant server 108 generates a transaction request that includes the purchase amount of the first product, the set of parameters, the details of the transaction card 106, and/or data fields that are pursuant to one or more standards for the interchange of transaction messages, such as the ISO8583 standard. The merchant server 108 transmits the transaction request to the acquirer server 110 by way of the payment gateway. The acquirer server 110 receives the transaction request and transmits the transaction request to the payment network server 112 to determine whether the account holder of the transaction card 106 has initiated the transaction and whether the available credit line or account balance corresponding to the transaction card 106 covers the purchase amount.

The first transceiver 206 receives the transaction request from the acquirer server 110. The first transaction manager 212 identifies the issuer server 114 that maintains the account from which the user 102 has performed the transaction, based on the details of the transaction card 106 included in the purchase request. The first pre-authorization manager 210 then retrieves the pre-authorization rules specified by the issuer bank of the issuer server 114 from the first memory 204. In one embodiment, the issuer server 114 hosts a pre-authorization application using which the issuer bank specifies the pre-authorization rules. The issuer bank may update the pre-authorization rules by using the pre-authorization application. The first pre-authorization manager 210 determines the hold duration for reserving the purchase amount, based on the set of parameters included in the transaction request and the pre-authorization rules specified by the issuer bank of the issuer server 114.

In one embodiment, the first pre-authorization manager 210 determines the hold duration, such that the hold duration is longer than the shipping time of the first product. For example, if the shipping time of the first product is four days, the first pre-authorization manager 210 determines the hold duration as seven days (i.e., longer than the shipping time). In another embodiment, the first pre-authorization manager 210 determines the hold duration based on the category and a first pre-authorization rule associated with the category. For example, if the first pre-authorization rule states that the products listed under the apparels category should have a hold duration of 15 days or less and the category of the first product is apparels, the first pre-authorization manager 210 determines the hold duration, such as ten days, that is less than or equal to 15 days. In yet another embodiment, the first pre-authorization manager 210 determines the hold duration based on the hold duration recommendation and the first pre-authorization rule. For example, if the first pre-authorization rule states that the products listed under the apparels category should have a hold duration of 15 days or less and the hold duration recommendation is of 18 days, the first pre-authorization manager 210 determines the hold duration, such as 15 days. In yet another embodiment, the first pre-authorization manager 210 determines the hold duration based on the shopper rating and a second pre-authorization rule associated with shopper rating. For example, the second pre-authorization rule states that the products purchased by users having a shopper rating of five should have a hold duration of 30 days or less, the products purchased by users having a shopper rating of three or four should have a hold duration of 10 days or less, and the products purchased by users having a shopper rating of two or one should not have any hold duration. In such a scenario, when the shopper rating of the user 102 is four, the first pre-authorization manager 210 determines the hold duration as 10 days or less.

It will be apparent to a person skilled in the art that the above-mentioned examples are for illustrative purposes and should not be construed to limit the scope of the invention. The first pre-authorization manager 210 may utilize a weighted sum of the parameters included in the set of parameters and a weighted sum of the pre-authorization rules for determining the hold duration for reserving the purchase amount.

The first pre-authorization manager 210 then generates the hold request for reserving the purchase amount from the account of the user 102 for the hold duration. The first transceiver 206 transmits the hold request to the issuer server 114. The hold request includes the hold duration, the details of the transaction card 106, the purchase amount, and/or data fields that are pursuant to one or more standards for the interchange of transaction messages, such as the ISO8583 standard. The issuer server 114 determines the account of the user 102 that is associated with the transaction card 106 based on the details of the transaction card 106 included in the hold request. The issuer server 114 then determines whether the available credit line or account balance of the account associated with the transaction card 106 covers the purchase amount. In one embodiment, when the available credit line or account balance of the account does not cover the purchase amount, the issuer server 114 declines the transaction and informs the merchant server 108.

In an alternate embodiment, when the available credit line or account balance of the account covers the purchase amount, the issuer server 114 performs an authentication of the user 102. In one example, the authentication is based on a one-time password (OTP) generated by the issuer server 114. In another example, the authentication is based on a secure password associated with the account. In one scenario, the user 102 is not the account holder of the account and may have tried to perform a fraudulent transaction. In such a scenario, when the authentication fails, the issuer server 114 declines the transaction. In an alternate scenario, the user 102 is the account holder of the account and may provide the OTP or the secure password by way of the registered contact number or the registered e-mail ID to the issuer server 114. The authentication is successful and the issuer server 114 reserves the purchase amount from the account of the user 102 for the hold duration.

It will be apparent to a person skilled in the art that the above-mentioned examples of user authentication are for illustrative purposes and should not be construed to limit the scope of the invention. In another embodiment, the issuer server 114 may use any other user authentication technique known in the art for authenticating the user 102, without departing from the spirit of the invention.

The issuer server 114 transmits a pre-authorization notification to the merchant server 108. The pre-authorization notification indicates that the purchase amount has been reserved from the account of the user 102 for the hold duration. The pre-authorization notification includes a unique transaction identification number (i.e., transaction ID). The issuer server 114 further informs the user 102 that the purchase amount is reserved from the account.

The merchant server 108 receives the pre-authorization notification and records the transaction in its memory (not shown). The merchant server 108 further transmits a purchase notification to the user-computing device 104 of the user 102. The purchase notification specifies an order ID associated with the purchase of the first product, the shipping time of the first product, and the hold duration for which the purchase amount is reserved from the account of the user 102. The user 102 may use the order ID to track the delivery of the first product. The merchant server 108 instructs the user 102 by way of the purchase notification to either accept the first product on delivery or initiate a return of the first product before the hold duration elapses by sending a message, such as a short message service (SMS). The hold duration begins, when the user 102 receives the purchase notification. The merchant manages the delivery of the first product to the user 102 and the merchant server 108 tracks the delivery.

In one scenario (as shown in FIG. 4A), the user 102 initiates a return of the first product before the hold duration elapses. The user 102 transmits a product return message to the merchant server 108, in response to the purchase notification, by using the user-computing device 104. The product return message includes the order ID associated with the purchase of the first product and a reason for returning the first product. For example, the user 102 initiates the return of the first product by specifying a reason that the first product was damaged. The merchant server 108 receives the product return message and identifies the transaction ID based on the order ID associated with the product return message. The merchant server 108 then transmits a cancel pre-authorization request to the payment network server 112. The cancel pre-authorization request includes the transaction ID.

The first transceiver 206 receives the cancel pre-authorization request. The first pre-authorization manager 210 cancels the pre-authorization and generates a release request. The first transceiver 206 transmits the release request to the issuer server 114. The release request indicates the transaction ID to the issuer server 114. The issuer server 114 receives the release request and identifies the account of the user 102 based on the transaction ID. The issuer server 114 then releases the purchase amount from the account of the user 102 and confirms the release of the purchase amount to the user 102 by way of a confirmation message. After the release, the purchase amount becomes available to the user 102 for use. The merchant then collects the first product from the user 102 and completes the purchase process.

With reference to FIG. 4B, the process flow diagram 400B illustrates a scenario when the user 102 accepts the first product within the hold duration. The user 102 transmits an acceptance message to the merchant server 108 by using the user-computing device 104. The acceptance message includes the order ID associated with the purchase of the first product. The merchant server 108 receives the acceptance message and identifies the transaction ID based on the order ID. The merchant server 108 then transmits a complete pre-authorization request to the payment network server 112. The complete pre-authorization request includes the transaction ID.

The first transceiver 206 receives the complete pre-authorization request. The first pre-authorization manager 210 completes the pre-authorization and generates a capture request. The first transceiver 206 transmits the capture request to the issuer server 114. The capture request indicates the transaction ID to the issuer server 114. The issuer server 114 receives the capture request and identifies the account of the user 102 based on the transaction ID. The issuer server 114 then captures the purchase amount from the account of the user 102 and confirms the capturing of the purchase amount to the user 102 by way of the confirmation message. After capture, the purchase amount is deducted from the account of the user 102 and is credited to the merchant account, and the purchase process completes.

With reference to FIG. 4C, the process flow diagram 400C illustrates a scenario when the user 102 neither accepts the first product nor initiates the return of the first product and the hold duration elapses. The merchant server 108 determines that the first product is delivered to the user 102 and the user 102 has neither accepted the first product nor initiated the return of the first product within the hold duration. In such a scenario, the merchant server 108 generates the complete pre-authorization request, when the hold duration elapses and transmits the complete pre-authorization request to the payment network server 112. Based on the complete pre-authorization request, the first pre-authorization manager 210 completes the pre-authorization and transmits the capture request to the issuer server 114. The issuer server 114 captures the purchase amount from the account of the user 102 based on the capture request and confirms the capture of the purchase amount to the user 102.

In one embodiment, the merchant server 108 transmits the cancel pre-authorization request or the complete pre-authorization request directly to the issuer server 114. The issuer server 114 then either cancels or completes the pre-authorization based on the cancel or complete pre-authorization requests, respectively.

Thus, the payment network server 112 of the communication environment 100 enables a timely refund of the purchase amount to the user 102 without causing any inconvenience to the merchant and the user 102. As the purchase amount is immediately reflected in the account of the user 102, when the user 102 initiates the return of the first product, the user 102 does not need to follow-up with the merchant server 108 and the issuer server 114 for the refund, thereby preventing the inconvenience caused to users by the conventional e-commerce systems. The payment network server 112 offers a dynamic solution to the determination of the hold duration. As the payment network server 112 determines the hold duration based on the set of parameters, the hold duration varies for different products and users. The payment network server 112 further takes into account the pre-authorization rules set by different issuer banks for determining the hold duration, which makes the determination of hold duration more dynamic. The payment network server 112 only reserves the purchase amount from the account of the user 102, when the user 102 purchases the first product. The actual deduction of the purchase amount happens only when the user 102 accepts the product or when the hold duration elapses. Thus, the payment network server 112 eliminates the need for the merchant server 108 to track the status of refunds of multiple customers, thereby reducing the processing overhead of the merchant server 108. The payment network server 112 provides a common platform for different merchants and issuer banks for facilitating online purchases. For example, the payment network server 112 does not require static merchant category codes for registering different merchants.

Referring now to FIGS. 5A-5C, process flow diagrams 500A-500C that illustrate exemplary scenarios for facilitating online purchases using the communication environment 100 of FIG. 1, in accordance with various embodiments of the present invention, are shown.

With reference to FIG. 5A, the process flow diagram 500A illustrates the user 102, who uses the user-computing device 104 to access the e-commerce website hosted by the merchant server 108 for purchasing the first product. The user 102 selects the first product and proceeds to perform the transaction to purchase the first product. The user 102 further provides the details of the transaction card 106 to the merchant server 108 for performing the transaction. In an alternate embodiment, the user 102 may select the net-banking payment mode for performing the transaction. In such a scenario, the user 102 provides the details of the account from which she wants to perform the transaction to the merchant server 108.

The merchant server 108 offers the pre-authorization option to the user 102, when the user 102 provides the details of the transaction card 106 or the account. The user 102 selects the pre-authorization option for performing the transaction and the purchase request is transmitted from the user-computing device 104 to the merchant server 108.

The merchant server 108 receives the purchase request and determines the set of parameters associated with the first product. The merchant server 108 then generates and transmits the transaction request to the acquirer server 110 by way of the payment gateway. The acquirer server 110 receives the transaction request.

In one embodiment, when the user 102 has selected the credit/debit card payment mode, the acquirer server 110 transmits the transaction request to the payment network server 112 to determine whether the account holder of the transaction card 106 has initiated the transaction and whether the available credit line or account balance associated with the transaction card 106 covers the purchase amount. The payment network server 112 then transmits the transaction request to the issuer server 114 which maintains the account of the user 102. In an alternate embodiment, when the user 102 has selected the net-banking payment mode, the acquirer server 110 transmits the transaction request directly to the issuer server 114 that maintains the account of the user 102.

The second transceiver 306 receives the transaction request from at least one of the payment network server 112 or the acquirer server 110. The second pre-authorization manager 310 determines the hold duration for reserving the purchase amount, based on the set of parameters included in the transaction request and the pre-authorization rules of the corresponding issuer bank. The second pre-authorization manager 310 determines the hold duration for reserving the purchase amount from the account of the user 102 in a similar manner as determined by the first pre-authorization manager 210 in FIG. 4A.

The second transaction manager 312 determines whether the available credit line or account balance associated with the transaction card 106 or the account covers the purchase amount. When the available credit line or account balance of the account covers the purchase amount, the second transaction manager 312 performs the authentication of the user 102. When the authentication is successful, the second pre-authorization manager 310 reserves the purchase amount from the account of the user 102 for the hold duration.

The second pre-authorization manager 310 generates the pre-authorization notification and the second transceiver 306 transmits the pre-authorization notification to the merchant server 108 to indicate the hold duration. The merchant server 108 receives the pre-authorization notification and records the transaction. The merchant server 108 further transmits the purchase notification to the user-computing device 104 of the user 102. The hold duration begins, when the user 102 receives the purchase notification.

In one scenario (as shown in FIG. 5A), the user 102 initiates the return of the first product before the hold duration elapses. The user 102 transmits the product return message to the merchant server 108 and based on the product return message the merchant server 108 transmits the cancel pre-authorization request to the issuer server 114. The second pre-authorization manager 310 cancels the pre-authorization and releases the purchase amount from the account of the user 102. The second pre-authorization manager 310 further confirms the release of the purchase amount to the user 102 by way of the confirmation message. After the release, the purchase amount becomes available to the user 102 for use. The merchant then collects the first product from the user 102 and completes the purchase process.

With reference to FIG. 5B, the process flow diagram 500B illustrates the scenario when the user 102 accepts the first product within the hold duration. The user 102 transmits the acceptance message to the merchant server 108 and the merchant server 108 transmits the complete pre-authorization request to the issuer server 114 based on the acceptance message. The second pre-authorization manager 310 then completes the pre-authorization and captures the purchase amount from the account of the user 102. The second pre-authorization manager 310 confirms the capturing of the purchase amount to the user 102 by way of the confirmation message. After capture, the purchase amount is deducted from the account of the user 102 and is credited to the merchant account.

With reference to FIG. 5C, the process flow diagram 500C illustrates a scenario when the user 102 neither accepts the first product nor initiates the return of the first product and the hold duration elapses. When the user 102 neither accepts nor initiates the return of the first product within the hold duration after the delivery of the first product, the merchant server 108 generates and transmits the complete pre-authorization request to the issuer server 114. Based on the complete pre-authorization request, the second pre-authorization manager 310 completes the pre-authorization and captures the purchase amount from the account of the user 102. The second pre-authorization manager 310 further confirms the capturing of the purchase amount to the user 102.

Thus, the issuer server 114 of the communication environment 100 enables a timely refund of the purchase amount to the user 102 without causing any inconvenience to the merchant and the user 102. The issuer server 114 further eliminates the requirement for the merchant server 108 to track the status of refunds of multiple customers, thereby reducing the processing overhead of the merchant server 108. The issuer server 114 provides a common platform that is independent of merchant category codes for facilitating online purchases.

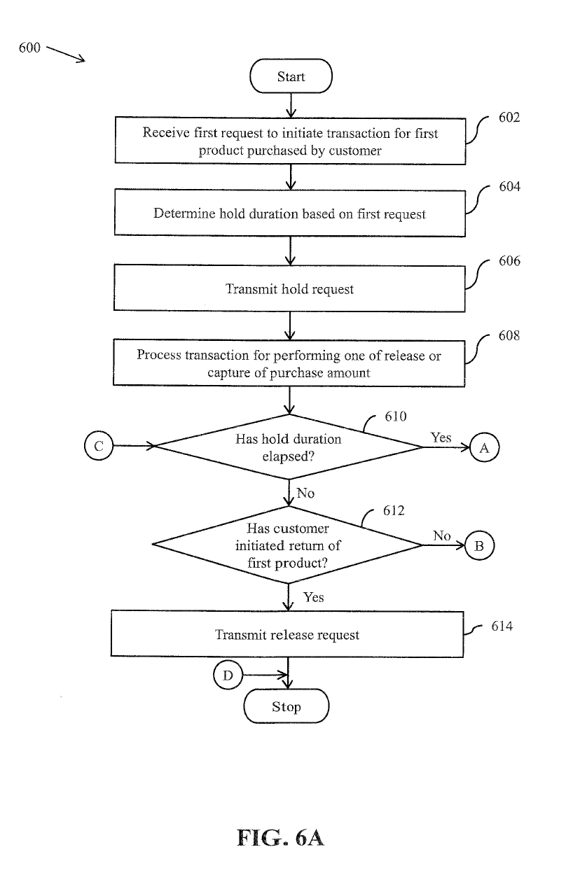

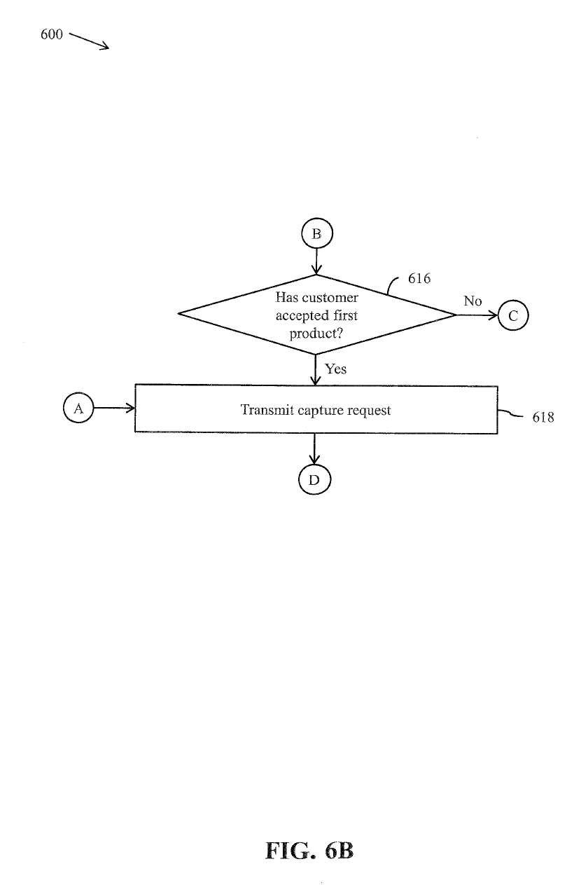

Referring now to FIGS. 6A and 6B, a flow chart 600 that illustrates a method for facilitating online purchases implemented using the communication environment 100 of FIG. 1, in accordance with an embodiment of the present invention, is shown. At step 602, the first transceiver 206 of the payment network server 112 receives a first request (i.e., the transaction request) from one of the merchant server 108 and the acquirer server 110 to initiate the transaction for the first product purchased by the user 102 (i.e., a customer). The first request includes the set of parameters and the purchase amount of the first product.

At step 604, the first pre-authorization manager 210 determines the hold duration for reserving the purchase amount from the account of the user 102 based on the first request (i.e., the transaction request). At step 606, the first transceiver 206, in conjunction with the first pre-authorization manager 210, transmits the hold request to the issuer server 114 for reserving the purchase amount from the account of the user 102. Based on the hold request, the issuer server 114 reserves the purchase amount from the account of the user 102 for the hold duration.

At step 608, the first pre-authorization manager 210 processes the transaction for performing one of the release or capture of the purchase amount from the account. At step 610, the first pre-authorization manager 210 determines whether the hold duration has elapsed. If at step 610, it is determined that the hold duration has not elapsed, step 612 is performed. At step 612, the first pre-authorization manager 210 determines whether the user 102 (i.e., the customer) has initiated the return of the first product based on the cancel pre-authorization request received from the merchant server 108. If at step 612, it is determined that the user 102 has initiated the return of the first product, the first pre-authorization manager 210 performs step 614. At step 614, the first transceiver 206, in conjunction with the first pre-authorization manager 210, transmits the release request to the issuer server 114. Based on the release request, the issuer server 114 releases the purchase amount from the account of the user 102 and informs the user 102 of the release of the purchase amount.

If at step 612, it is determined that the user 102 has not initiated the return of the first product, step 616 is performed. At step 616, the first pre-authorization manager 210 determines whether the user 102 (i.e., the customer) has accepted the first product based on the complete pre-authorization request received from the merchant server 108. If at step 616, it is determined that the user 102 has accepted the first product, step 618 is performed. At step 618, the first transceiver 206, in conjunction with the first pre-authorization manager 210, transmits the capture request to the issuer server 114. Based on the capture request, the issuer server 114 captures the purchase amount from the account of the user 102 and informs the user 102 that the purchase amount is captured.

If at step 616, it is determined that the user 102 has not accepted the first product, step 610 is performed. If at step 610, it is determined that the hold duration has elapsed, step 618 is performed and the purchase process is completed.

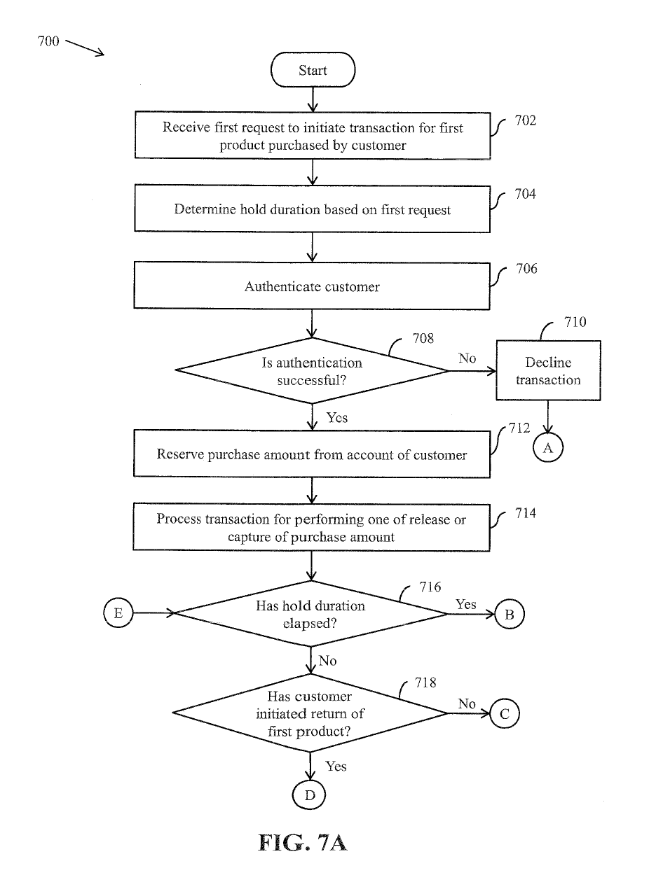

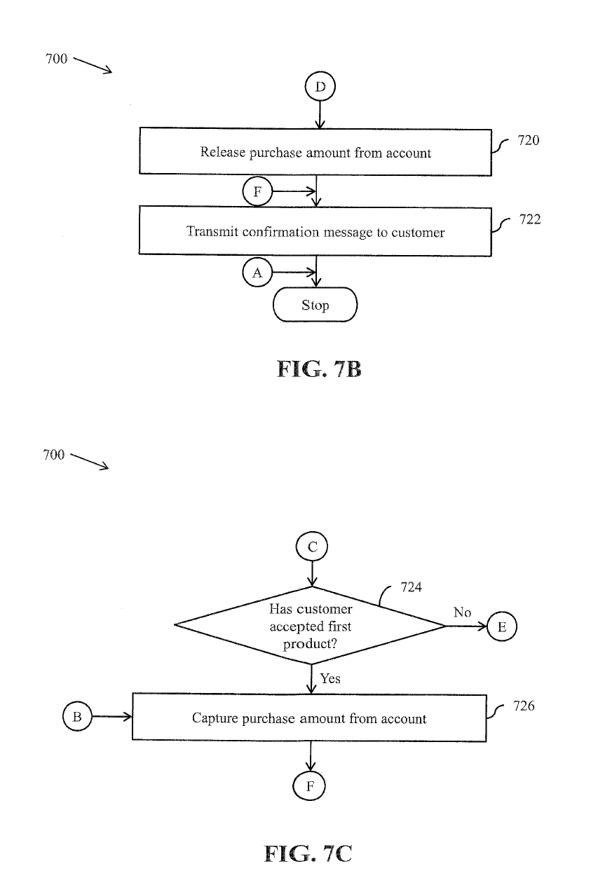

Referring now to FIGS. 7A-7C, a flow chart 700 that illustrates a method for facilitating online purchases implemented using the communication environment 100 of FIG. 1, in accordance with another embodiment of the present invention, is shown. At step 702, the second transceiver 306 receives the first request (i.e., the transaction request) from one of the merchant server 108, the acquirer server 110, and the payment network server 112 to initiate the transaction for the first product purchased by the user 102 (i.e., the customer). The first request includes the set of parameters and the purchase amount of the first product.

At step 704, the second pre-authorization manager 310 determines the hold duration for reserving the purchase amount from the account of the user 102 based on the first request. At step 706, the second transaction manager 312 authenticates the user 102. At step 708, the second transaction manager 312 determines whether the authentication is successful. If at step 708, it is determined that the authentication has failed, step 710 is performed. At step 710, the second transaction manager 312 declines the transaction and informs the user 102 and the merchant server 108. If at step 708, it is determined that the authentication is successful, step 712 is performed.

At step 712, the second pre-authorization manager 310 reserves the purchase amount from the account of the user 102 for the hold duration and informs the merchant server 108 that the purchase amount is reserved. At step 714, the second pre-authorization manager 310 processes the transaction for performing one of the release or capture of the purchase amount from the account. At step 716, the second pre-authorization manager 310 determines whether the hold duration has elapsed. If at step 716, it is determined that the hold duration has not elapsed, step 718 is performed. At step 718, the second pre-authorization manager 310 determines whether the user 102 (i.e., the customer) has initiated the return of the first product based on the cancel pre-authorization request received from the merchant server 108. If at step 718, it is determined that the user 102 has initiated the return of the first product, step 720 is performed. At step 720, the second pre-authorization manager 310 releases the purchase amount from the account of the user 102. At step 722, the second transceiver 306, in conjunction with the second pre-authorization manager 310, transmits the confirmation message to the user-computing device 104 for informing the user 102 about the release of the purchase amount.

If at step 718, it is determined that the user 102 has not initiated the return of the first product, step 724 is performed. At step 724, the second pre-authorization manager 310 determines whether the user 102 (i.e., the customer) has accepted the first product based on the complete pre-authorization request received from the merchant server 108. If at step 724, it is determined that the user 102 has accepted the first product, step 726 is performed. At step 726, the second pre-authorization manager 310 captures the purchase amount from the account of the user 102 and performs step 722 to inform the user 102 that the purchase amount is captured.

If at step 724, it is determined that the user 102 has not accepted the first product, step 716 is performed. If at step 716, it is determined that the hold duration has elapsed, step 726 is performed and the purchase process completes.

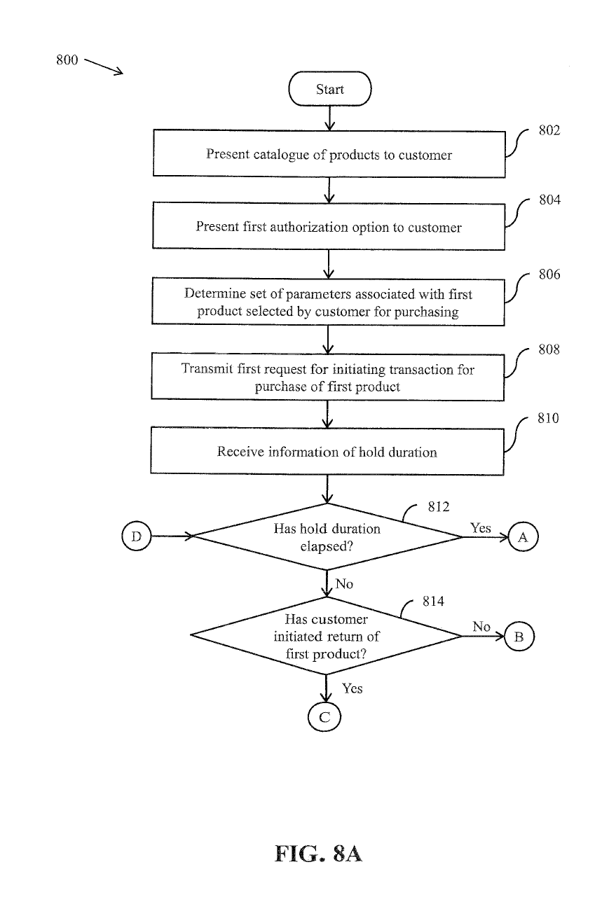

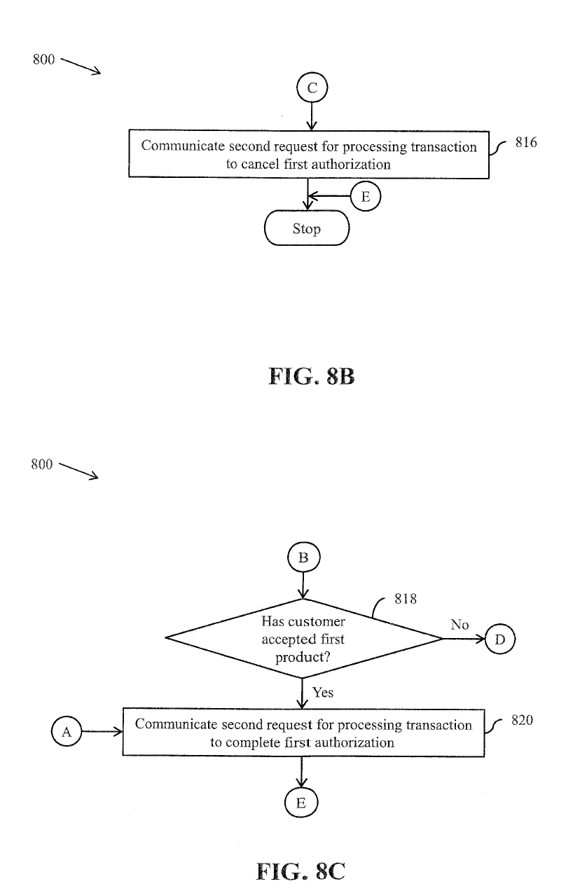

Referring now to FIGS. 8A-8C, a flow chart 800 that illustrates a method for facilitating online purchases implemented using the communication environment 100 of FIG. 1, in accordance with yet another embodiment of the present invention, is shown. At step 802, the merchant server 108 presents the catalog of the products to the user 102 (i.e., the customer) through the e-commerce website or the mobile application. At step 804, the merchant server 108 presents the first authorization option (i.e., the pre-authorization option) to the user 102, when the user 102 selects the first product for purchasing. At step 806, the merchant server 108 determines the set of parameters (as described in the foregoing) associated with the first product selected by the user 102 for purchasing, when the user 102 selects the first authorization option. The set of parameters includes the category of the first product, the shipping time associated with the delivery of the first product to the user 102, the hold duration recommendation, or the rating of the user 102.

At step 808, the merchant server 108 transmits the first request (i.e., the transaction request) to one of the acquirer server 110, the payment network server 112, and the issuer server 114 for initiating the transaction for the purchase of the first product. The first request includes the set of parameters and the purchase amount of the first product.

At step 810, the merchant server 108 receives the information pertaining to the hold duration determined by one of the payment network server 112 and the issuer server 114. The merchant server 108 records the transaction and informs the user 102 regarding the hold duration by transmitting the purchase notification. At step 812, the merchant server 108 determines whether the hold duration has elapsed. If at step 812, it is determined that the hold duration has not elapsed, step 814 is performed. At step 814, the merchant server 108 determines whether the user 102 (i.e., the customer) has initiated the return of the first product. If at step 814, it is determined that the user 102 has initiated the return of the first product, step 816 is performed.

At step 816, the merchant server 108 communicates a second request (i.e., the cancel pre-authorization request) to one of the payment network server 112 and the issuer server 114 for processing the transaction to cancel the first authorization (i.e., the pre-authorization). Based on the second request (i.e., the cancel pre-authorization request), the issuer server 114 releases the purchase amount from the account of the user 102 and informs the user 102 about the release of the purchase amount.

If at step 814, it is determined that the user 102 has not initiated the return of the first product, step 818 is performed. At step 818, the merchant server 108 determines whether the user 102 (i.e., the customer) has accepted the first product. If at step 818, it is determined that the user 102 has accepted the first product, step 820 is performed. At step 820, the merchant server 108 communicates the second request (i.e., the complete pre-authorization request) to one of the payment network server 112 and the issuer server 114 for processing the transaction to complete the first authorization. Based on the second request (i.e., the complete pre-authorization request), the issuer server 114 captures the purchase amount from the account of the user 102 and informs the user 102 about the release of the purchase amount.

If at step 818, it is determined that the user 102 has not accepted the first product, step 812 is performed. If at step 812, it is determined that the hold duration has elapsed, the step 820 is performed and the purchase process completes.

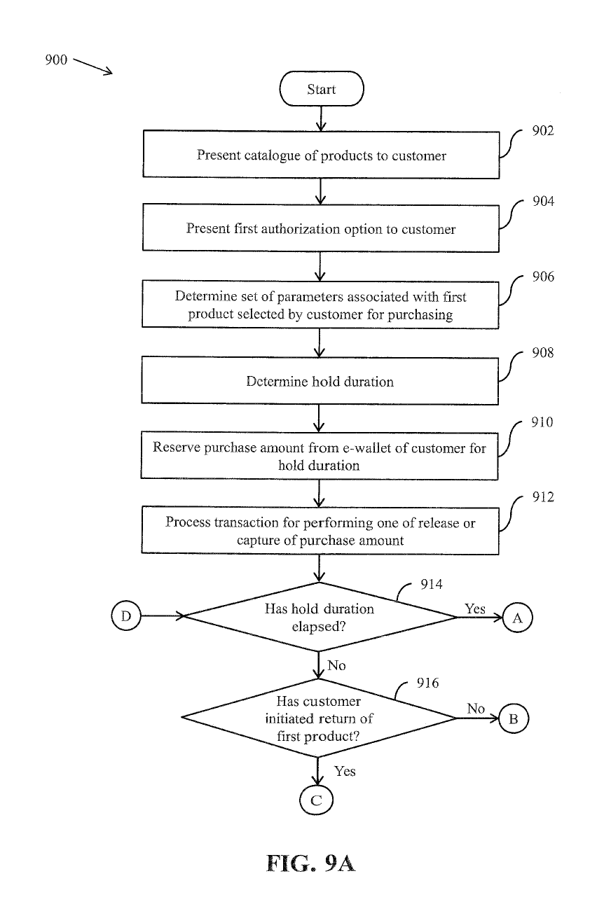

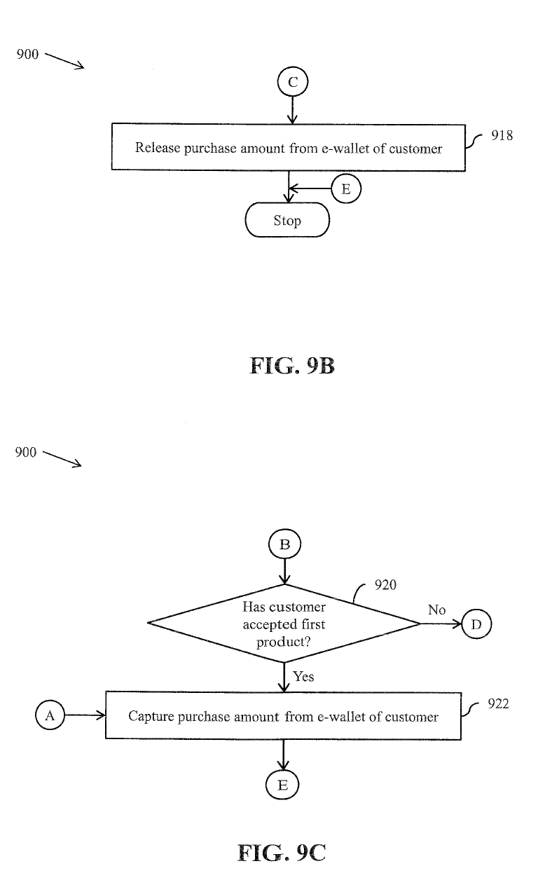

Referring now to FIGS. 9A-9C, a flow chart 900 that illustrates a method for facilitating online purchases implemented using the communication environment 100 of FIG. 1, in accordance with yet another embodiment of the present invention, is shown. At step 902, the merchant server 108 presents the catalog of the products to the user 102 (i.e., the customer) through the e-commerce website or the mobile application. At step 904, the merchant server 108 presents the first authorization option (i.e., the pre-authorization option) to the user 102, when the user 102 selects the first product for purchasing. At step 906, the merchant server 108 determines the set of parameters associated with the first product selected by the user 102 for purchasing, when the user 102 selects the first authorization option.

At step 908, the merchant server 108 determines the hold duration for reserving the purchase amount from an e-wallet of the user 102, such that the merchant server 108 maintains the e-wallet of the user 102. The merchant server 108 informs the user 102 regarding the hold duration by transmitting the purchase notification. The merchant server 108 further authenticates the user 102 and performs step 910, when the authentication is successful. At step 910, the merchant server 108 reserves the purchase amount from the e-wallet of the user 102 for the hold duration. At step 912, the merchant server 108 processes the transaction to perform one of the release or capture of the purchase amount from the e-wallet of the user 102.

At step 914, the merchant server 108 determines whether the hold duration has elapsed. If at step 914, it is determined that the hold duration has not elapsed, step 916 is performed. At step 916, the merchant server 108 determines whether the user 102 (i.e., the customer) has initiated the return of the first product. If at step 916, it is determined that the user 102 has initiated the return of the first product, step 918 is performed. At step 918, the merchant server 108 releases the purchase amount from the e-wallet of the user 102 and informs the user 102 about the release of the purchase amount.

If at step 916, it is determined that the user 102 has not initiated the return of the first product, step 920 is performed. At step 920, the merchant server 108 determines whether the user 102 (i.e., the customer) has accepted the first product. If at step 920, it is determined that the user 102 has accepted the first product, step 922 is performed. At step 922, the merchant server 108 captures the purchase amount from the e-wallet of the user 102 and informs the user 102 about the release of the purchase amount. If at step 920, it is determined that the user 102 has not accepted the first product, step 914 is performed. If at step 914, it is determined that the hold duration has elapsed, step 922 is performed and the purchase process completes.

It will be apparent to one skilled in the art that the scope of the invention is not limited to the merchant server 108 maintaining the e-wallet of the user 102. In an alternate embodiment, a third-party server may maintain the e-wallet of the user 102 and the merchant server 108 communicates with the third-party server for the reservation, capture, and/or release of the purchase amount from the e-wallet of the user 102, without departing from the spirit of the invention.

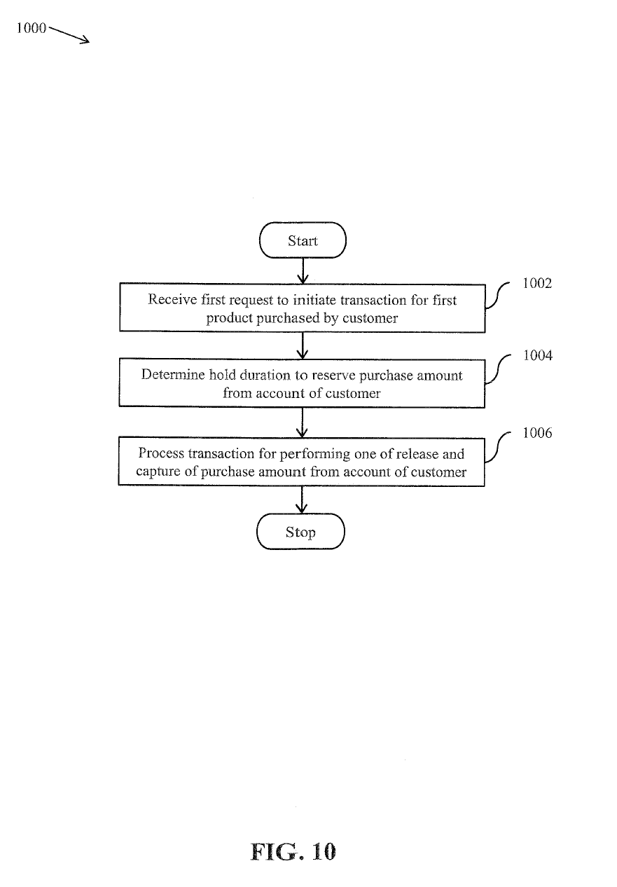

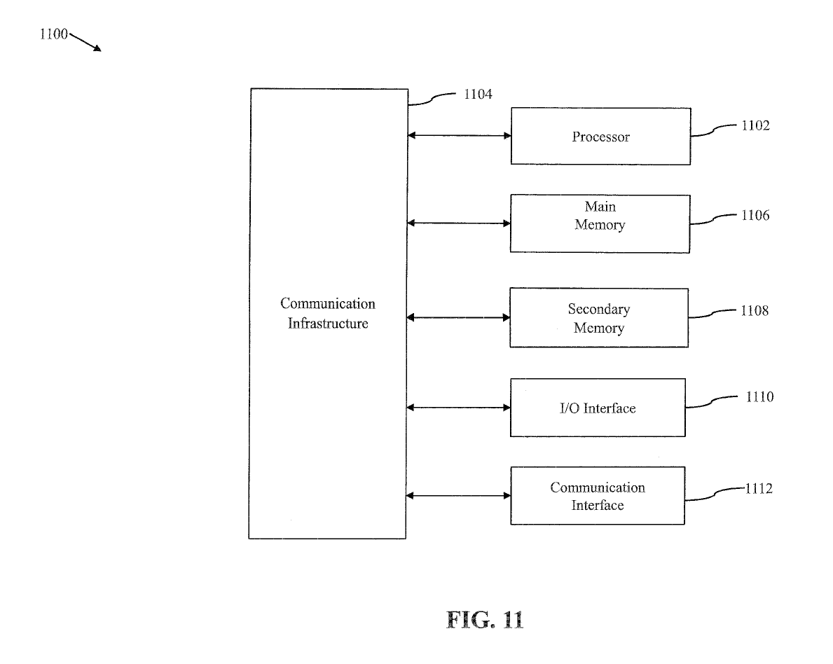

Referring now to FIG. 10, a high-level flow chart 1000 that illustrates a method for facilitating online purchases implemented using the communication environment 100 of FIG. 1, in accordance with an embodiment of the present invention, is shown. At step 1002, a server (such as the merchant server 108, the payment network server 112, or the issuer server 114) receives the first request (i.e., the transaction request) to initiate the transaction for the first product purchased by the user 102 (i.e., the customer). The first request includes the purchase amount and/or the set of parameters. At step 1004, the server (i.e., the merchant server 108, the payment network server 112, or the issuer server 114) determines the hold duration for reserving the purchase amount from the account of the user 102 (i.e., the customer), based on the first request. At step 1006, the server (i.e., the merchant server 108, the payment network server 112, or the issuer server 114) processes the transaction for performing one of the release and the capture of the purchase amount from the account of the user 102, based on the hold duration and the action performed by the user 102. The action performed by the user 102 is one of the initiation of the return of the first product and the acceptance of the first product. The purchase amount is released from the account, when the user 102 initiates the return of the first product within the hold duration. The purchase amount is captured from the account, when the user 102 accepts the first product within the hold duration. The purchase amount is further captured from the account, when the user 102 neither accepts nor initiates the return of the first product within the hold duration and the hold duration elapses.

Referring now to FIG. 11, a block diagram that illustrates system architecture of a computer system 1100, in accordance with an embodiment of the present invention is shown. An embodiment of present invention, or portions thereof, may be implemented as computer readable code on the computer system 1100. In one example, the user-computing device 104, the merchant server 108, the acquirer server 110, the payment network server 112, and the issuer server 114 of FIG. 1 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIGS. 6A and 6B, 7A-7C, 8A-8C, 9A-9C, and 10.

The computer system 1100 includes a processor 1102 that may be a special-purpose or a general-purpose processing device. The processor 1102 may be a single processor, multiple processors, or combinations thereof. The processor 1102 may have one or more processor cores. In one example, the processor 1102 is an octa-core processor. Further, the processor 1102 may be connected to a communication infrastructure 1104, such as a bus, i.e., the first and second buses 208 and 308, message queue, multi-core message-passing scheme, and the like. The computer system 1100 may further include a main memory 1106 and a secondary memory 1108. Examples of the main memory 1106 may include RAM, ROM, and the like. In one embodiment, the main memory 1106 is one of the first and second memories 204 and 304. The secondary memory 1108 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1100 further includes an input/output (I/O) interface 1110 and a communication interface 1112. The I/O interface 1110 includes various input and output devices that are configured to communicate with the processor 1102. Examples of the input devices may include a keyboard, a mouse, a joystick, a touchscreen, a microphone, and the like. Examples, of the output devices may include a display screen, a speaker, headphones, and the like. The communications interface 1112 may be configured to allow data to be transferred between the computer system 1100 and various devices that are communicatively coupled to the computer system 1100. Examples of the communications interface 1112 may include a modem, a network interface, i.e., an Ethernet card, a communications port, and the like. Data transferred via the communications interface 1112 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 1100. Examples of the communications channel may include, but are not limited to, cable, fiber optics, a phone line, a cellular phone link, a radio frequency link, and the like.

Computer program medium and computer usable medium may refer to memories, such as the main memory 1106 and the secondary memory 1108, which may be a semiconductor memory such as a DRAM. These computer program mediums may provide data that enables the computer system 1100 to implement the methods illustrated in FIGS. 6A and 6B, 7A-7C, 8A-8C, 9A-9C, and 10. In an embodiment, the present invention is implemented using a computer implemented application, the computer implemented application may be stored in a computer program product and loaded into the computer system 1100 using the removable storage drive or the hard disc drive in the secondary memory 1108, the I/O interface 1110, or communications interface 1112.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 1102 and a memory such as the main memory 1106 and the secondary memory 1108 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the communication environment 100 enables a timely refund of purchase amounts without causing any inconvenience to merchants and customers. Since the purchase amount is immediately reflected in the account of the user 102, when the user 102 initiates the return of the first product, there is no need for the user 102 to follow-up with the merchant server 108 and the issuer server 114 for the refund. Further, the merchant server 108 does not need to track the status of refunds, as the purchase amount is only reserved at the time of purchase and actually captured, when the user 102 accepts the first product or when the hold duration elapses, thereby reducing the processing overhead of merchant server 108. The communication environment 100 provides a platform that uses pre-authorization and is independent of merchant category codes for facilitating online purchases.

Techniques consistent with the present invention provide, among other features, systems and methods for facilitating online purchases. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for facilitating online purchases, the method comprising:
receiving, by a first server, a first request to initiate a transaction for a product purchased by a customer, wherein the first request comprises at least one of a purchase amount of the product and a set of parameters;
determining, by the first server, a hold duration to reserve the purchase amount from an account of the customer, based on the first request; and
processing, by the first server, the transaction for performing one of a release and a capture of the purchase amount from the account, wherein the purchase amount is released, when the customer initiates a return of the product within the hold duration.

2. The method of claim 1, wherein the purchase amount is captured from the account, when the customer accepts the product within the hold duration.

3. The method of claim 1, wherein the purchase amount is captured from the account, when the hold duration elapses.

4. The method of claim 1, wherein the set of parameters includes at least a category of the product, a shipping time associated with a delivery of the product to the customer, a hold duration recommendation, or a rating of the customer.

5. The method of claim 1, further comprising authenticating, by the first server, the customer for reserving the purchase amount, based on the first request.

6. The method of claim 1, wherein the first server receives the first request from one of a second server or a computing device of the customer.

7. A system for facilitating online purchases, the system comprising:
an issuer server comprising:
a processor that is configured to:
receive a first request from a merchant server to initiate a transaction for a product purchased by a customer, wherein the first request comprises at least a purchase amount of the product and a set of parameters;
determine a hold duration to reserve the purchase amount from an account of the customer, based on the first request; and
process the transaction for performing one of a release and a capture of the purchase amount from the account based on the hold duration, wherein the purchase amount is released, when the customer initiates a return of the product within the hold duration.

8. The system of claim 7, wherein the processor is further configured to reserve the purchase amount from the account for the hold duration.

9. The system of claim 7, wherein the processor is further configured to release the purchase amount from the account, when the customer initiates the return of the product within the hold duration.

10. The system of claim 7, wherein the processor is further configured to capture the purchase amount from the account, when the customer accepts the product within the hold duration.

11. The system of claim 7, wherein the processor is further configured to capture the purchase amount from the account, when the hold duration elapses.

12. The system of claim 7, wherein the processor is further configured to authenticate the customer for reserving the purchase amount, based on the first request.

13. The system of claim 7, wherein the set of parameters includes at least a category of the product, a shipping time associated with a delivery of the product to the customer, a hold duration recommendation, or a rating of the customer.

14. The system of claim 13, wherein the hold duration is longer than the shipping time of the product.

15. A method for facilitating online purchases, the method comprising:
presenting, by a merchant server, a first authorization option on a computing device of a customer by way of a merchant web site, when the customer selects a product, listed for sale on the merchant web site, for purchasing;
determining, by the merchant server, a set of parameters, when the customer selects the first authorization option;
transmitting, by the merchant server to a first server, a first request to initiate a transaction for the purchase of the product, wherein the first request includes the set of parameters and a purchase amount of the product;
receiving, by the merchant server, information of a hold duration from the first server based on the first request, wherein the purchase amount is reserved from an account of the customer for the hold duration; and
communicating, by the merchant server, a second request to the first server for processing the transaction, wherein the first server processes the transaction for performing one of a release and a capture of the purchase amount from the account, and wherein the purchase amount is released, when the customer initiates a return of the product within the hold duration.

16. The method of claim 15, wherein the set of parameters includes at least a category of the product, a shipping time associated with a delivery of the product to the customer, a hold duration recommendation, or a rating of the customer.

17. The method of claim 15, further comprising transmitting, by the merchant server to the computing device, a purchase notification to indicate the information of the hold duration to the customer.

18. The method of claim 17, further comprising receiving, by the merchant server from the computing device, a response to the purchase notification, wherein the customer provides the response within the hold duration to indicate one of an acceptance of the product and an initiation of the return of the product.

19. The method of claim 15, wherein the purchase amount is captured from the account, when the customer accepts the product within the hold duration.

20. The method of claim 15, wherein the purchase amount is captured from the account, when the hold duration elapses.
